(19) United States
(12) Patent Application Publication
(10) Pub. No.: US 2010/0141561 A1
(43) Pub. Date: Jun. 10, 2010

(54) Plasma display device

(76) Inventors: Du-Yeon Han, Suwon-si (KR); Hee-Hwan Kim, Suwon-si (KR); Yong-Jin Kim, Suwon-si (KR); Keun-Young Song, Suwon-si (KR); Hyun-Woo Lee, Suwon-si (KR); Seung-Yong Lee, Suwon-si (KR); Kyung-Sub Shim, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/591,975

(22) Filed: Dec. 7, 2009

(30) Foreign Application Priority Data
Dec. 8, 2008 (KR) 10-2008-0124110

(51) Int. Cl. G09G 3/28

(52) U.S. Cl. 345/60

(57) ABSTRACT

A plasma display device includes a PDP including discharge cells, address electrodes extending in a first direction and corresponding to the discharge cells, and sustain electrodes and scan electrodes in parallel with each other and crossing the address electrodes in the discharge cells, the sustain electrodes including first terminals and the scan electrodes including second terminals, a chassis base supporting PDP, an integrated board on the chassis base, the chassis base being between the integrated board and the PDP, and an integrated flexible circuit connecting the integrated board to the first terminals of the sustain electrodes and to the second terminals of the scan electrodes, the first terminals of the sustain electrodes and second terminals of the scan electrodes being arranged at a first side of four sides of the PDP.

### BACKGROUND

1. Field

Embodiments relate to a plasma display device. More particularly, embodiments relate to a plasma display device which connects sustain electrodes and scan electrodes to an integrated board.

2. Description of the Related Art

In general, a plasma display device includes a plasma display panel (PDP) for displaying an image, a chassis base that supports the PDP, and a plurality of printed circuit board assemblies (PBAs) which are mounted on the chassis base and connected to the PDP.

The PDP may generate plasma through gas discharge and may excite phosphors by using vacuum ultra-violet (VUV) radiation emitted from the plasma, thereby displaying an image by using visible light of red (R), green (G), and/or blue (B) obtained by stabilizing the excited phosphors.

For gas discharge, the PDP may include address electrodes and display electrodes (sustain and scan electrodes) which may cross each other and correspond to discharge cells. The address electrodes and the display electrodes may be respectively connected to corresponding boards of the PBAs via a flexible printed circuit (FPC).

For example, the conventional PBAs may include a sustain board for controlling sustain electrodes, a scan board for controlling scan electrodes, and an address buffer board for controlling address electrodes. The scan electrodes may be independently controlled by being independently connected to the scan board via a first FPC. The sustain electrodes may be commonly controlled by being commonly connected to the sustain board via a second FPC.

In such a plasma display device, however, a sustain board and a scan board may be formed to have separate structures, i.e., as discrete elements, thus making the module complex and hard to manufacture. Further, devices performing the same function, i.e., active devices and passive devices, may be provided on the sustain board and on the scan board, respectively, thus increasing manufacturing complexity and costs further.

The above information disclosed in this Background section is only for enhancement of understanding of the background of the invention and therefore it may contain information that does not form the prior art that is already known in this country to a person of ordinary skill in the art.

### SUMMARY

Example embodiments are therefore directed to a plasma display device, which substantially overcomes one or more of the problems due to the limitations and disadvantages of the related art.

It is therefore a feature of an embodiment to provide a plasma display device having a PDP with sustain electrodes and scan electrodes connected to an integrated board in a simplified structure, thereby reducing costs by commonly using devices on the integrated board.

At least one of the above and other features and advantages may be realized by providing a plasma display device, including a PDP with address electrodes extending in a first direction corresponding to discharge cells and sustain electrodes and scan electrodes formed in parallel with each other corresponding to the discharge cells while crossing the address electrodes in the discharge cells, a chassis base supporting the plasma display panel, and an integrated board mounted on the chassis base on the opposite side of the plasma display panel, first terminals of the sustain electrodes and second terminals of the scan electrodes being formed at one of four sides of the plasma display panel, and the integrated board being connected to the first and second terminals via an integrated flexible circuit.

For a pair of the discharge cells neighboring each other in the first direction, the sustain electrodes may include a first sustain electrode and a second sustain electrode, and the scan electrodes may include a first scan electrode and a second scan electrode, and the sustain electrodes and the scan electrodes may be arranged in the order of the first scan electrode, the first sustain electrode, the second sustain electrode, and the scan electrode.

The first sustain electrode and the second sustain electrode may be connected to a same first terminal in a non-display area formed on edges of a display area.

The each of first scan electrode and the second scan electrode may be respectively connected to two second terminals disposed at both sides of the first direction, with the first terminal interposed therebetween.

For a pair of discharge cells neighboring each other in the first direction, the first terminals may be formed as one unit, and the second terminals may be formed as two units, so the first and second sustain electrodes and the first and second scan electrodes may be connected to one first terminal and two second terminals.

The second terminals may have the same length as the first terminals by being formed longer than the first terminals and cut out after aging to have a substantially same length. A number of the first terminals may equal about half a number of the second terminals.

The integrated flexible circuit may include first pins connected to the first terminals, and second pins connected to the second terminals.

The number of first pins may be half the number of second pins.

The integrated flexible circuit may include: a first sheet and a second sheet that are attached to each other so as to form the first pins therebetween; and a third sheet that is attached to the second sheet so as to form the second pins therebetween, the third sheet being shorter than the second sheet so as to expose the second pins corresponding to the second terminals, and the second sheet having via holes corresponding to spaces between the second pins so as to expose the first pins corresponding to the first terminals.

The plasma display panel may have a non-display area formed on edges of the display area, and include a short bar formed on the opposite side of the first terminals in the second direction, the sustain electrodes being commonly connected to the short bar.

The plasma display panel may include auxiliary sustain electrodes which are formed in the non-display area on at least one of both sides of the first direction and connected to the short bar.

The auxiliary sustain electrodes may be connected to the integrated board via the integrated flexible circuit.

The integrated flexible circuit may include third pins which are connected to auxiliary terminals of the auxiliary sustain electrodes.

The auxiliary sustain electrodes may include a first auxiliary sustain electrode and a second auxiliary sustain electrode which are respectively formed at both sides of the first direction of the non-display area and connect the short bar to the integrated flexible circuit.

The first and second terminals of respective sustain and scan electrodes may be arranged only along one side of the PDP extending along the first direction. The integrated flexible circuit for connecting the sustain and scan electrodes may be positioned only along one side of the PDP.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates an exploded perspective view of a plasma display device according to an exemplary embodiment;

FIG. 2 illustrates an exploded perspective view of a PDP in the plasma display device of FIG. 1;

FIG. 3 illustrates a cross sectional view along line in FIG. 2;

FIG. 4 illustrates a top plan view of the PDP in FIG. 2;

FIG. 5 illustrates an unfolded front view of a connection between the PDP and an integrated board in the plasma display device of FIG. 1;

FIG. 6 illustrates a detailed view of a pattern of sustain electrodes and scan electrodes in the PDP of FIG. 1 with respect to a connection to the integrated flexible circuit of FIG. 1; and

FIG. 7 illustrates a partial exploded perspective view of the integrated flexible circuit of FIG. 1.

### DETAILED DESCRIPTION

Korean Patent Application No. 10-2008-0124110, filed on Dec. 8, 2008, in the Korean Intellectual Property Office, and entitled: “Plasma Display Device,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

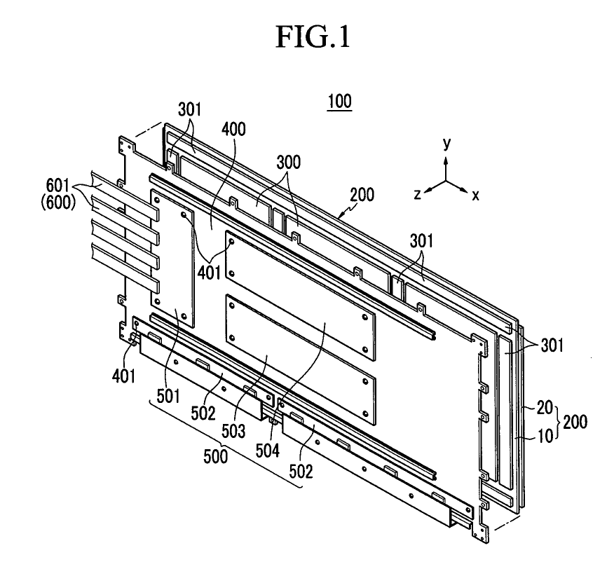

FIG. 1 illustrates an exploded perspective view of a plasma display device according to an exemplary embodiment of the present invention. Referring to FIG. 1, the plasma display device 100 may include a plasma display panel 200 for displaying an image using gas discharge, heat dissipation sheets 300, a chassis base 400, and PBAs 500.

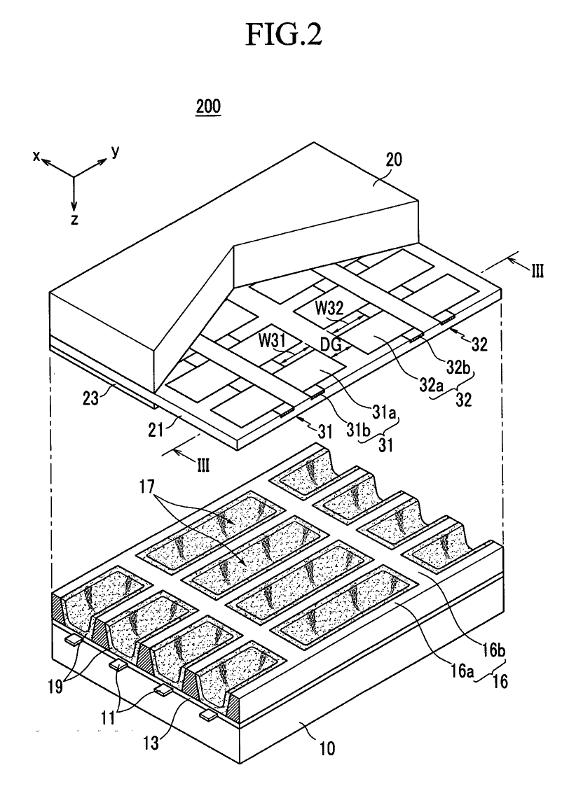

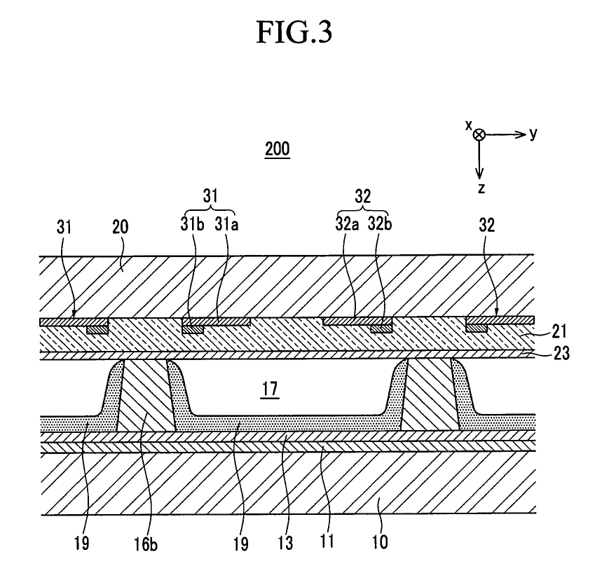

FIG. 2 illustrates an exploded perspective view of the PDP 200, and FIG. 3 illustrates a cross sectional view along line in FIG. 2. For convenience, the PDP 200 will be described hereinafter.

Referring to FIGS. 2 and 3, the PDP 200 may include a rear substrate 10 and a front substrate 20 facing each other and having a space therebetween, and barrier ribs 16 provided between the rear and front substrates 10 and 20.

The barrier ribs 16 may define a plurality of discharge cells 17 between the rear and front substrate 10 and 20 by partitioning a space between the rear substrate 10 and the front substrate 20. The discharge cells 17 may be filled with a discharge gas (for example, a gas mixture including neon (Ne) and xenon (Xe)), and may include phosphor layers 19.

The discharge gas may generate vacuum ultraviolet (VUV) rays by the gas discharge, and the phosphor layers 19 may be excited by the VUV rays. The phosphor layers 19 may emit visible light when stabilized after the VUV excitation.

In order to generate the gas discharge in the discharge cells 17, address electrodes 11, a sustain electrode 31, and a scan electrode 32 may be disposed between the rear substrate 10 and the front substrate 20 to correspond to the discharge cells 17.

The address electrodes 11 may extend on an inner surface of the rear substrate 10, i.e., a surface facing the front substrate 20, along a first direction, e.g., a y-direction in the figures. The address electrodes 11 may sequentially correspond to the discharge cells 17 that are adjacent to each other along the first direction.

A first dielectric layer 13 may cover the inner surface of the rear substrate 10 and the address electrodes 11. The first dielectric layer 13 may prevent or substantially minimize damage to the address electrodes 11 from charged particles, e.g., positive ions or electrons generated upon gas discharge, and may form and accumulate wall charges for the gas discharge.

The barrier ribs 16 may include first barrier rib members 16a and second barrier rib members 16b that form the discharge cells 17 in a matrix format. The first barrier rib members 16a may be respectively extended in the y-axis direction, and may be disposed in parallel to each other with predetermined intervals therebetween along the x-axis direction. The second barrier rib members 16b may be disposed between the first barrier rib members 16a in parallel to each other with predetermined intervals therebetween along the y-axis direction. The second barrier rib members 16b may extend in the x-axis direction.

A phosphor paste may be coated on side surfaces of the barrier ribs 16 and a surface of the first dielectric layer 13 surrounded by the barrier ribs 16. The coated phosphor paste may be dried and baked to form the phosphor layers 19 in the discharge cells 17.

The sustain electrode 31 and the scan electrode 32 may be formed on an inner surface of the front substrate 20, i.e., a surface of the front substrate 20 facing the rear substrate 10, while corresponding to the discharge cells 17. The sustain electrode 31 and the scan electrode 32 may form a surface discharge configuration to generate the gas discharge in the respective cells 17.

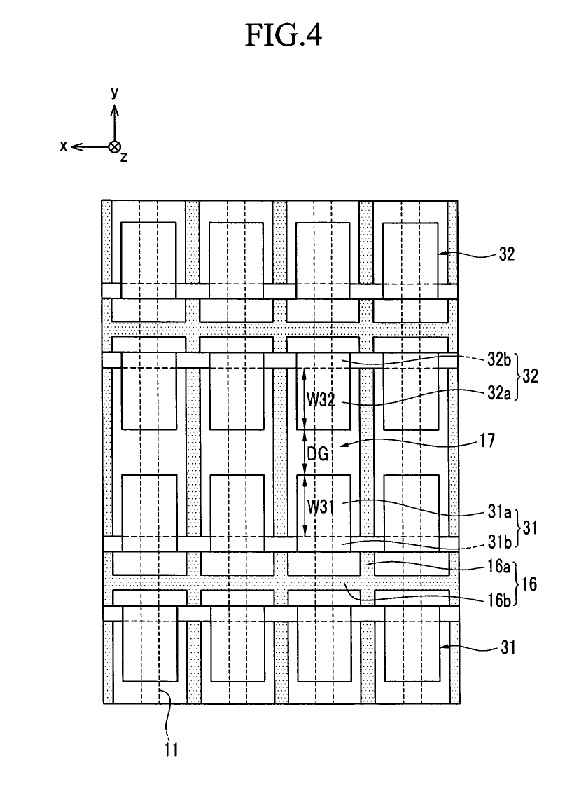

FIG. 4 illustrates a top plan view of the PDP of FIG. 2. Referring to FIG. 4, the sustain electrode 31 and the scan electrode 32 may extend in the second direction, e.g., along the x-axis direction. The second direction may cross the first direction, e.g., cross the address electrodes 11.

The sustain electrode 31 and the scan electrode 32 may include transparent electrodes 31a and 32a, respectively, for generating discharge. The sustain electrode 31 and the scan electrode 32 may further include bus electrodes 31b and 32b, respectively, for applying voltage signals to the respective transparent electrodes 31a and 32a.

Since the transparent electrodes 31a and 32a are disposed inside the discharge cell 17, they may be formed of a transparent material, e.g., indium tin oxide (ITO), to obtain an increased aperture ratio of the discharge cell 17. The bus electrodes 31b and 32b may be formed of a metallic material having excellent electrical conductivity, in order to apply the voltage signals to the transparent electrodes 31a and 32a.

The transparent electrodes 31a and 32a may protrude along the y-axis from an edge of the discharge cell 17, e.g., from a peripheral portion along a contour of the discharge cells 17, to a center of the discharge cell 17 to be disposed in a center part of the discharge cell 17. That is, the transparent electrodes 31a and 32a may be formed with respective widths W31 and W32 to form a discharge gap DG.

The bus electrodes 31b and 32b may extend in the x-axis direction along edges of the discharge cells 17, e.g., along a contour of the discharge cell 17, to be respectively disposed on the transparent electrodes 31a and 32a. Accordingly, voltage signals applied to the bus electrodes 31b and 32b may be respectively transmitted to be applied to the transparent electrodes 31a and 32a to correspond to the discharge cells 17.

Referring again to FIG. 2 and FIG. 3, a second dielectric layer 21 may cover the inner surface of the front substrate 20, the sustain electrode 31, and the scan electrode 32. The second dielectric layer 21 may prevent or substantially minimize damage to the sustain electrode 31 and the scan electrode 32 from charged particle, e.g., positive ions or electrons generated upon gas discharge, and may form and accumulate wall charges for the gas discharge.

A protective layer 23 may cover the second dielectric layer 21. For example, the protective layer 23 may be formed, e.g., of transparent MgO through which visible light may be transmitted, to protect the second dielectric layer 21 from positive ions or electrons generated upon gas discharge, and may increase a secondary electron emission coefficient.

When the rear substrate 10 and the front substrate 20 are adhered to each other, the barrier rib 16 on the rear substrate 10 and the protective layer 23 on the front substrate 20 may contact each other. A fine passage (not shown) defined between the barrier rib 16 and the protective layer 23 may function to allow air to be exhausted from the discharge cells 17 and to fill the discharge gas in the discharge cells 17.

The PDP 200 may perform an address discharge by the address electrode 11 and the scan electrode 32 to select turn-on discharge cells 17. The PDP 200 may perform a sustain discharge by the sustain electrode 31 and the scan electrode 32 disposed in the selected discharge cells 17 to drive the selected discharge cells 17 and to realize an image.

Referring again to FIG. 1, the heat dissipation sheets 300 in the plasma display device may be provided between the rear substrate 10 of the PDP 200 and the chassis base 400. The heat dissipation sheets 300 may dissipate heat generated from the PDP 200 due to gas discharge along a planar surface of the PDP 200.

The chassis base 400 may be attached to the rear substrate 10 of the PDP 200 using a double-sided tape 301 to support the PDP 200. The heat dissipation sheets 300 may be interposed between the PDP 200 and the chassis base 400.

The PBAs 500 may be mounted on a rear surface of the chassis base 400, i.e., a surface of the chassis base 400 facing away from the PDP 200. The PBAs 500 may be electrically connected to the PDP 200 to drive the PDP 200.

The PBAs 500 may be placed on a plurality of bosses (not shown), which may be provided on the chassis base 400, and may be fixed to the bosses by set screws 401, which may be fastened to the bosses, to attach the PBAs 500 to the chassis base 400. The PBAs 500 may be formed, e.g., compartmentally, to perform respective functions for driving the PDP 200.

For example, the PBAs 500 may include an integrated board 501 for controlling the sustain electrodes 31 and the scan electrodes 32, and an address buffer board 502 for controlling the address electrodes 11. Further, the PBAs 500 may include an image processing/controlling board 503. The image processing/controlling board 503 may receive image signals from an external source, may generate control signals for driving the address electrodes 11 and the sustain and scan electrodes 31 and 32 according to the received image signals, and apply the control signals to the corresponding of the boards 501 and 502. The PBAs 500 may further include a power board 504 for supplying power needed for driving the boards 501, 502, and 503.

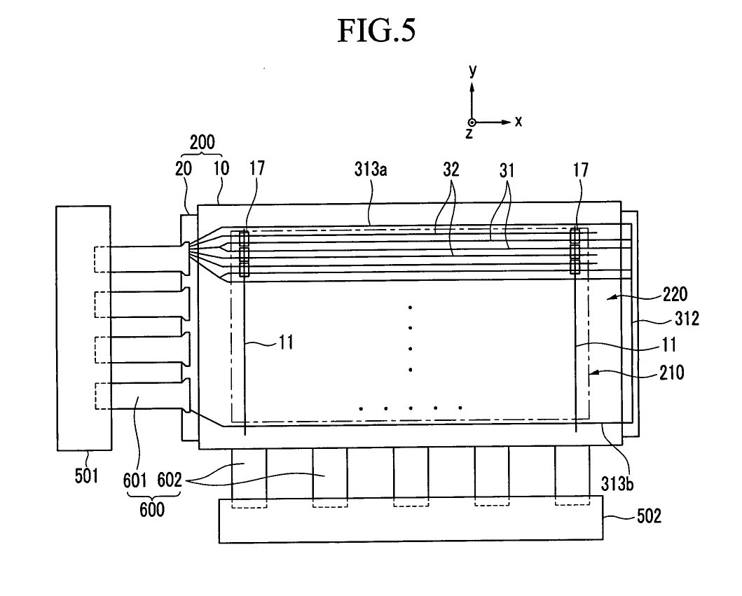

The PBAs 500 may be connected to the respective electrodes via a flexible circuit 600. For example, the integrated board 501 may be connected to the sustain electrodes 31 and the scan electrodes 32 via an integrated flexible circuit 601, and the address buffer board 502 may be connected to the address electrodes 11 via an address flexible circuit 602 (see FIG. 5).

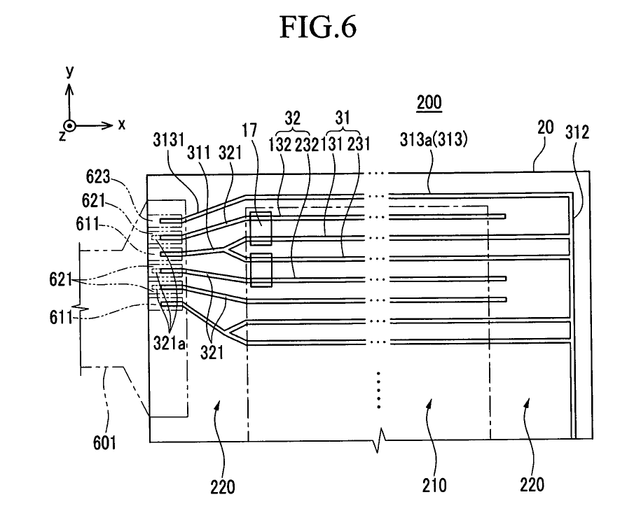

FIG. 5 illustrates an unfolded, front view of a connection between the electrodes of the PDP 200 and respective PBAs 500 via the flexible circuit 600. FIG. 6 illustrates a detailed view of a pattern and connection of the sustain electrodes 31 and scan electrodes 32 in the PDP 200 to the flexible circuit 600.

Referring to FIGS. 5 and 6, the integrated flexible circuit 601 may connect the sustain electrodes 31 and the scan electrodes 32 to the integrated board 501. For this, first terminals 311 of the sustain electrodes 31 and second terminals 321 of the scan electrodes 32 may be formed in parallel to each other at one side of the PDP 200.

For convenience, transparent electrodes 31a and 32a of the sustain and scan electrodes 31 and 32 are not illustrated in FIG. 5 and FIG. 6. The first terminals 311 of the sustain electrodes 31 and second terminals 321 of the scan electrodes 32 in FIG. 5 and FIG. 6 extend to the bus electrodes 31b and 32b, respectively.

The PDP 200 may have, e.g., a rectangular shape having four sides. For example, the PDP 200 may include a pair of short sides facing each other and extending along the y-axis, and a pair of long sides facing each other and extending along the x-axis.

The address electrodes 11 may extend in the y-axis direction. As illustrated in FIG. 5, edges of the address electrodes 11 may extend out of a display area 210 of the PDP 200 to be connected to the address buffer board 502 via the address flexible circuit 602. In this regard, it is noted that the display area 210 of the PDP may display an image, and a non-display area 220 may be formed on edges of the display area 210.

The sustain and scan electrodes 31 and 32 may extend in the x-axis direction. As illustrated in FIGS. 5 and 6, edges of the sustain and scan electrodes 31 and 32 may extend out of the display area 210 to be connected to the integrated flexible circuit 601 via the first terminals 311 and the second terminals 321, respectively. The first terminals 311 of the sustain electrodes 31 and the second terminals 321 of the scan electrodes 32 may be formed at a same side, e.g., at a same left short side of FIGS. 5 and 6, of the PDP 200. The first terminals 311 and the second terminals 321 may be parallel to each other, and may be connected to the integrated board 501 via the integrated flexible circuit 601.

The integrated board 501 may have devices (not shown), e.g., one or more of an Energy Recovery Circuit (ERC) condenser, a sustain voltage condenser, and an ERC switch. Therefore, the integrated board 501 may enable a common use of the devices, i.e., with respect to both sustain and scan electrodes 31 and 32.

Arrangement of the sustain and scan electrodes 31 and 32 and their respective terminals in the plasma display device will be described hereafter. As illustrated in FIGS. 5 and 6, in the PDP 200, a pair of discharge cells 17 adjacent to each other along the y-axis direction may correspond to two sustain electrodes 31, e.g., a first sustain electrode 131 and a second sustain electrode 231, and two scan electrodes 32, e.g., a first scan electrode 132 and a second scan electrode 232.

That is, a pair of discharge cells 17 adjacent to each other in the y-axis direction may correspond to the sustain electrodes 31 and the scan electrodes 32, which may be arranged, e.g., in the order of the first scan electrode 132, the first sustain electrode 131, the second sustain electrode 231, and the second scan electrode 232. For example, the first sustain electrode 131 and the first scan electrode may correspond to a same discharge cell 17.

Therefore, as the sustain electrodes 31 or the scan electrodes 32 are continuously disposed between the discharge cells 17 adjacent, i.e., neighboring, each other in the y-axis direction, electrostatic capacity between the discharge cells 17 may be reduced. Thus, a reactive power consumption of the PDP 200 may be decreased.

In a pair of discharge cells 17 neighboring each other in the y-axis direction, the first sustain electrode 131 and the second sustain electrode 231 may be connected to one of the first terminals 311 in the non-display area 220. In other words, the first and second sustain electrodes 131 and 231 of two adjacent discharge cells 17 in the y-axis may be connected to a same first terminal 311.

The first scan electrode 132 and the second scan electrode 232 of the two adjacent discharge cells 17 along the y-axis may be connected to two of the second terminals 321 in the non-display area 220. For example, each of the first and second scan electrodes 132 and 232 of the two adjacent discharge cells 17 along the y-axis may be connected to a separate second terminal 321. As illustrated in FIG. 6, the first terminal 311 connected to the first and second sustain electrodes 131 and 231 may be interposed between, i.e., as oriented along the y-axis, the two second terminals 321 connected to the first and second scan electrodes 132 and 232.

Therefore, a pair of discharge cells 17 neighboring each other in the y-axis direction may correspond to one first terminal 311, i.e., formed as one unit, and to two second terminals 321, i.e., formed as two units. That is, a number of first pins 611, i.e., pins connecting the first terminals 311 to the integrated flexible circuit 601, may be half a number of second pins 621, i.e., pins connecting the second terminals 321 to the integrated flexible circuit 601, because a number of the first terminals 311 may be half a number of the second terminals 321. In other words, a total number of the first terminals 311 may be less than a total number of the sustain electrodes 31.

As the number of the first terminals 311 is less than the number of the sustain electrodes 31, it may be easier to form the first terminals 311 and the second terminals 321 in parallel with each other on one side of the PDP 200. For example, a reduced number of terminals 311 may reduce a required space on the non-display area 202 of the PDP 200 for forming terminals, so that the first and second terminals 311 and 321 may be formed only on one side of the PDP 200.

The second terminals 321 connected to the first and second scan electrodes 132 and 232 may be formed to have longer edges than edges of the first-terminals 211 connected to the first and second sustain electrodes 131 and 231, followed by cutting after aging. Therefore, in a final PDP 200, edges of the first and second terminals 211 and 321, i.e., portions of the first and second terminals 211 and 321 on respective first and second pins 611 and 621, may have a substantially same length, i.e., along the x-axis.

FIG. 6 illustrates cut out portions 321a, i.e., portions of the second terminals 321 cut after aging, with a dashed line. During aging, an aging voltage may be applied to the second terminals 321 and a short bar 312, i.e., a bar connecting the sustain electrodes 31 as will be discussed in more detail below.

As illustrated in FIG. 6, the integrated flexible circuit 601 may include the first pins 611, the second pins 621, and third pins 623. That is, the first pins 611 may be connected to the first terminals 311 of the sustain electrodes 31, and the second pins 621 may be connected to the second terminals 321 of the scan electrodes 32.

In the integrated flexible circuit 601, the number of the first pins 611 may be half the number of the second pins 621. As the number of the first pins 611 is less than the number of the second pins 621, it may be easier to form the first pins 611 and the second pins 621 in parallel with each other on the integrated flexible circuit 601.

Resultantly, because a total number of the first terminals 311 and the second terminals 321 may be less than a total number of the sustain electrodes 31 and the scan electrodes 32, the sustain and scan electrodes 31 and 32 drawn out to one side of the PDP 200 may be connected to the integrated board 501 via the integrated flexible circuit 601.

While each scan electrodes 32 may be independently connected to the integrated board 501, i.e., since the scan electrodes 32 may be independently controlled, the sustain electrodes 31 may be interconnected on the integrated board 501, i.e., because the sustain electrodes 31 may be commonly controlled (not shown).

The PDP 200 may include the short bar 312. The short bar 312 may be formed along a side of the PDP 200, i.e., an opposite side of the first terminals 311. For example, the short bar 312 may be formed along a short side of the PDP 200, so that the short bar 312 may longitudinally extend in the y-axis direction on the front substrate 20 in the non-display area 220. The sustain electrodes 31 may be commonly connected to the short bar 312, as illustrated in FIG. 6.

A sustain voltage may be applied to the sustain electrodes 31 via the first terminals 311, or may be applied thereto via the short bar 312. For this, the PDP 200 may include auxiliary sustain electrodes 313 which may be formed along the long sides of the PDP 200, i.e., along the x-axis.

The auxiliary sustain electrodes 313 may be formed at one long side or both long sides of the PDP 200, and may be connected to the short bar 312. The auxiliary sustain electrodes 313 may be connected to the integrated board 501 via the integrated flexible circuit 601. Auxiliary terminals 3131 of the auxiliary sustain electrodes 313 may be connected to the third pins 623 of the integrated flexible circuit 601. For example, the auxiliary sustain electrodes 313 may include a first auxiliary sustain electrode 313a and a second auxiliary sustain electrode 313b formed in the non-display area 220 at both long sides of the PDP 220, respectively.

The auxiliary sustain electrodes 313 may be portions additionally formed on the sustain electrodes 31, and may prevent a voltage drop in the sustain electrodes 31 by reducing impedance when a sustain voltage is applied from the integrated board 501 to the sustain electrodes 31. For example, since the first auxiliary sustain electrode 313a and the second auxiliary sustain electrode 313b are provided at the two long sides of the PDP 200 and are connected to the short bar 312, an impedance difference between the sustain electrodes 31 disposed along the y-axis direction may be decreased, thereby preventing a voltage difference between the sustain electrodes 31.

That is, a sustain voltage may be applied to the sustain electrodes 31 via the first terminals 311 on the integrated board 501. Simultaneously, the sustain voltage may be applied to the first and second auxiliary sustain electrodes 313a and 313b via the auxiliary terminals 3131 and to the sustain electrodes 31 via the short bar 312.

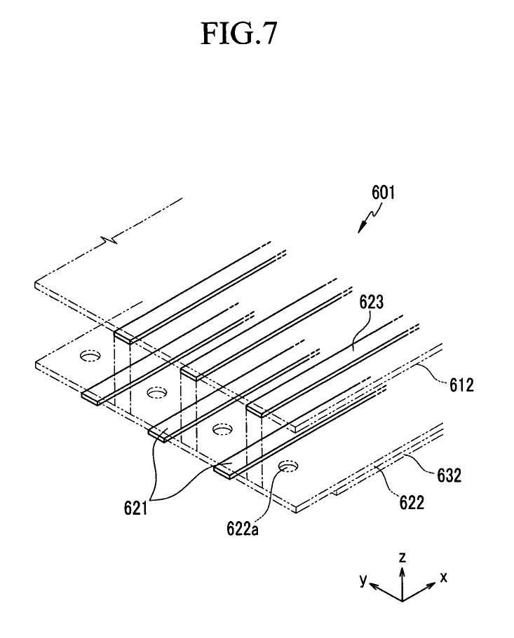

FIG. 7 illustrates a partial exploded perspective view of the integrated flexible circuit 601. Referring to FIG. 7, the integrated flexible circuit 601 may include a first sheet 612 and a second sheet 622. The first and second sheets 612 and 622 may be attached to each other, so that the first and third pins 611 and 623 may be formed therebetween. A third sheet 632 may be attached to the second sheet 622, so that the second pins 621 may be formed between the second and third sheets 632 and 632. The second sheet 622 may be between the first and third sheets 612 and 632. The first through third sheets 611 through 632 may be parallel to each other in the xy-plane, e.g., sequentially stacked on each other with the pins therebetween.

That is, the integrated flexible circuit 601 may include two-layered circuit patterns electrically separated from each other, so that the first and auxiliary terminals 311 and 3131 may be connected to the integrated board 501 independently of, i.e., separately of, the second terminals 321. One of the circuit patterns may be a circuit pattern connected to the first and auxiliary terminals 311 and 3131 by the first and third pins 611 and 631, and the other circuit pattern may be a circuit pattern connected to the second terminals 321 by the second pins 621.

Although the first and third pins 611 and 631 may be formed on a different layer with respect to the second pins 621, the first, second, and third pins 611, 621, and 631 may be connected to respectively correspond to the first, second, and auxiliary terminals 311, 321, and 3131.

For this, the third sheet 632 may be shorter, i.e., as measured along the x-axis, than the second sheet 622 at one end, so that the second pins 621 corresponding to the second terminals 321 may be exposed. In other words, since the second pins 621 may be between the second and third sheets 622 and 632, a shorter third sheet 632 may expose portions of the second pins 621. Accordingly, the second pins 621 may be electrically connected, e.g., directly, to the second terminals 321.

Further, the second sheet 622 may have via holes 622a corresponding to spaces between the second pins 621, so portions of the first pins 611 corresponding to the first terminals 311 may be exposed through the via holes 622a. Accordingly, the first pins 611 may be electrically connected to the first terminals 311 via the via holes 622a.

The plasma display device 100 according to exemplary embodiments of the present invention may have an integrated board 501 on the PDP with a corresponding single flexible integrated circuit 601. For example, instead of having two flexible circuits at both short sides of the PDP 200, the plasma display device 100 may have an integrated flexible circuit 601 at only one short side of the PDP 200. Accordingly, a number of flexible circuits in the plasma display device 100 may be reduced as compared to a conventional device, i.e., a device having flexible circuits at two short sides thereof, thereby simplifying the module.

As described above, according to exemplary embodiments of the present invention, the first terminals of the sustain electrodes and the second terminals of the scan electrodes may be formed at one side, e.g., only one short side, of the PDP, and may be connected to the integrated board via the integrated flexible circuit, thus simplifying the module.

Moreover, according to exemplary embodiments of the present invention, devices on the integrated board for controlling the sustain electrodes and the scan electrodes may be commonly used, so that costs may be decreased. For example, devices, e.g., an ERC condenser, a sustain voltage condenser, and an ERC switch, may be commonly used for controlling the sustain electrodes and the scan electrodes.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display device, comprising:
a plasma display panel (PDP), the PDP including discharge cells, address electrodes extending in a first direction and corresponding to the discharge cells, and sustain electrodes and scan electrodes in parallel with each other and crossing the address electrodes in the discharge cells, the sustain electrodes including first terminals and the scan electrodes including second terminals;
a chassis base supporting the PDP;
an integrated board on the chassis base, the chassis base being between the integrated board and the PDP; and
an integrated flexible circuit connecting the integrated board to the first terminals of the sustain electrodes and to the second terminals of the scan electrodes, the first terminals of the sustain electrodes and second terminals of the scan electrodes being arranged at a first side of four sides of the PDP.

2. The plasma display device as claimed in claim 1, wherein the sustain and scan electrodes are arranged in a repeating order of a first scan electrode, a first sustain electrode, a second sustain electrode, and a second scan electrode.

3. The plasma display device as claimed in claim 2, wherein the first sustain electrode and the second sustain electrode are connected to a same first terminal in a non-display area of the PDP.

4. The plasma display device as claimed in claim 3, wherein each of the first scan electrode and the second scan electrode is connected to a respective second terminal of two second terminals in the non-display area of the PDP, the same first terminal being between the two second terminals.

5. The plasma display device as claimed in claim 2, wherein the first and second sustain electrodes are connected to one first terminal and the first and second scan electrodes are connected to two second terminals.

6. The plasma display device as claimed in claim 5, wherein edges of the second terminals contacting the integrated flexible circuit have a substantially same length as edges of the first terminals contacting the integrated flexible circuit.

7. The plasma display device as claimed in claim 2, wherein a number of the first terminals equals about half a number of the second terminals.

8. The plasma display device as claimed in claim 1, wherein the integrated flexible circuit includes first pins connected to the first terminals and second pins connected to the second terminals.

9. The plasma display device as claimed in claim 8, wherein a number of the first pins equals about half a number of the second pins.

10. The plasma display device as claimed in claim 9, wherein the integrated flexible circuit includes:
a first sheet on a second sheet attached to each other, the first pins being between the first and second sheets; and
a third sheet on the second sheet, the second sheet being between the first and third sheets, and the second pins being between the second and third sheets.

11. The plasma display device as claimed in claim 10, wherein:
the third sheet is shorter than the second sheet, portions of the second pins being exposed by the third sheet, and
the second sheet having via holes corresponding to spaces between the second pins, the via holes exposing the first pins.

12. The plasma display device as claimed in claim 1, wherein the PDP includes a short bar in a non-display area thereof, the short bar being arranged along a second side of the PDP opposite the first side of the PDP, the sustain electrodes being commonly connected to the short bar.

13. The plasma display device as claimed in claim 12, wherein the PDP includes auxiliary sustain electrodes in the non-display area along at least one of third and fourth sides of the PDP, the auxiliary sustain electrodes being connected to the short bar, and the fourth and third sides being perpendicular to the first and second sides.

14. The plasma display device as claimed in claim 13, wherein the auxiliary sustain electrodes are connected to the integrated board via the integrated flexible circuit.

15. The plasma display device as claimed in claim 14, wherein the integrated flexible circuit includes third pins connected to auxiliary terminals of the auxiliary sustain electrodes.

16. The plasma display device as claimed in claim 13, wherein the auxiliary sustain electrodes include a first auxiliary sustain electrode and a second auxiliary sustain electrode on the third and fourth sides, respectively.

17. The plasma display device as claimed in claim 1, wherein the first and second terminals of respective sustain and scan electrodes are arranged only along one side of the PDP extending along the first direction.

18. The plasma display device as claimed in claim 1, wherein the integrated flexible circuit for connecting the sustain and scan electrodes is positioned only along one side of the PDP.
